(19) United States
(12) Patent Application Publication
(10) Pub. No.: US 2011/0151058 A1
(43) Pub. Date: Jun. 23, 2011

(54) DRINK, HYDROGEN-REDUCED WATER AND PRODUCTION METHOD AND STORAGE METHOD THEREFOR

(76) Inventor: Yoshiaki Yoshida, Toyama (JP)

(21) Appl. No.: 12/735,613

(22) PCT Filed: Jan. 28, 2009
(86) PCT No.: PCT/JP2009/051351

§ 371 Date: Mar. 1, 2011

(30) Foreign Application Priority Data
Feb. 4, 2008 (JP) 2008-024318
Jul. 31, 2008 (JP) 2008-198122

(51) Int. Cl. C01B 5/00; A23L 2/00; A23L 2/42; A23L 2/54

(52) U.S. Cl. 426/67; 426/66; 426/524

(57) ABSTRACT

An object of the present invention is to provide hydrogen-reduced water which contains a relatively large amount of dissolved hydrogen as a reactive substance having a relatively high reaction rate with respect to active oxygen in human body, has a relatively high rate of temperature change, and therefore is able to efficiently remove active oxygen, and also provide a production method and a storage method of the hydrogen-reduced water. To achieve the object, the present invention provides hydrogen-reduced water, having under a predetermined temperature condition a rate of temperature change higher than that of a water not containing hydrogen therein.

### TECHNICAL FIELD

The present invention relates to a drink, a hydrogen-reduced water, and production method and a storage method thereof and, in particular, to a hydrogen-reduced water having a relatively high rate of temperature change.

### PRIOR ART

A function of discharging waste products in human body is a function necessary for maintaining human health. When the function of discharging waste products deteriorates, various disorders may occur such as: an allergic disease like pollinosis, atopy, asthma, and the like; a disease of the digestive system such as stomach cancer, colon cancer, and the like; and other diseases such as hypertension, stroke, cerebral infarction, cardiac infarction, diabetes and the like.

Preventing or avoiding these diseases is essential to leading a comfortable social life. As a preventative measure, various methods such as dietetic treatment and pharmaceutical treatment have been proposed and implemented. However, in actuality, a large number of people are still suffering the above-stated diseases.

It has been generally said that active oxygen in human body affects occurrence of the above-stated diseases. It has been known that the above-stated diseases can be improved by removing active oxygen from the body.

To remove active oxygen in human body, it is necessary to incorporate into the body a substance (reactive substance) that is reacted with active oxygen and enhance the reaction rate of the reactive substance with respect to the active oxygen.

To increase the reaction rate, it is considered that a reactive substance having the higher rate of temperature change is the better, i.e. a reactive substance of which temperature increases (or decreases), for example, to a water temperature of the human body at the higher rate, the better. The higher rate of temperature change causes the reaction to become uniform in the shorter period of time and thus results in the higher reaction rate. In general, when the temperature during a reaction increases by 10° C., the reaction rate increases by about three times.

Incidentally, it is said that hydrogen-reduced water exhibiting a minus value as oxidation reduction potential is effective to remove active oxygen. Such hydrogen-reduced water as described above is generally produced by an electrolytic method.

JP 2002-254078 Laid-Open discloses an invention which utilizes a characteristic fact that hydrogen molecules tend to gather on a negative electrode side at the time of electrolysis of water and on this basis collecting, as reduced water, water having a relatively high hydrogen concentration in the vicinity of the negative electrode side.

The reduced water obtained through an electrolytic method as described above is called either “electrolytic reduced water” to differentiate it from natural water having reducibility or “alkaline reduced water” because it is collected as alkalized water on the negative electrode side.

Further, the present inventor has proposed in JP 2006-116504 Laid-Open a technique of: filling a pressure vessel with hydrogen gas instead of carrying out electrolysis of water; introducing raw water into the pressure vessel to bring the raw water into contact with the hydrogen gas, while maintaining the pressure of the hydrogen gas in the pressure vessel within a predetermined range, thereby dissolving the hydrogen gas in the pressure vessel in the raw water to produce hydrogen reduced water.

Further, JP 08-276104 Laid-Open discloses a method of removing dissolved oxygen in an aqueous solution by introducing activated hydrogen gas into the aqueous solution.

However, in each of the inventions described in JP 2002-254078, JP 2006-116504 and JP 08-276104, the rate of temperature change of the substance reactive to active oxygen is not sufficiently high because of the relatively low rate of temperature change of the hydrogen-reduced water, whereby there is a problem that active oxygen cannot be removed efficiently. Further, the invention of JP 08-276104 relates to a technique of bubbling hydrogen gas in an aqueous solution and it is difficult to dissolve a large amount of hydrogen gas in the aqueous solution therein.

### DISCLOSURE OF THE INVENTION

### Problems to be Solved by the Invention

An object of the present invention is to provide hydrogen-reduced water which contains a relatively large amount of dissolved hydrogen as a reactive substance having a relatively high reaction rate with respect to active oxygen in human body, has a relatively high rate of temperature change, and therefore is able to efficiently remove active oxygen, and also provide a production method and a storage method of the hydrogen-reduced water.

In order to achieve the object described above, the primary characteristics of the present invention are as follows:

(1) A hydrogen-reduced water, having under a predetermined temperature condition a rate of temperature change higher than that of a water not containing hydrogen therein.

(2) The hydrogen-reduced water according to (1) above, wherein concentration of dissolved hydrogen thereof is 1.8 ppm or more at 20° C.

(3) The hydrogen-reduced water according to (1) or (2) above, wherein concentration of dissolved oxygen thereof is 2.55 ppm or lower at 20° C.

(4) The hydrogen-reduced water according to any of (1) to (3) above, wherein oxidation reduction potential thereof at 20° C. is −500 mV or lower.

(5) The hydrogen-reduced water according to any one of (1) to (4) above, wherein a fluctuation range of oxidation reduction potential of the hydrogen-reduced water in a frozen state is 4% or lower when the hydrogen-reduced water is stored in the state for a long period of time in a container made of a hydrogen-permeable material.

(6) A drink, produced from the hydrogen-reduced water according to any one of (1) to (5) above.

(7) A method of producing the hydrogen-reduced water according to any of (1) to (5) above, the method including the step of spraying, into a vessel filled with hydrogen gas pressurized at a pressure in a predetermined range, raw water in a form of mist having a concentration of dissolved oxygen lowered by bubbling nitrogen gas into the raw water.

(8) A method of storing the hydrogen-reduced water according to any of (1) to (5) above, including the step of storing the hydrogen-reduced water for a long period of time in a state where the hydrogen-reduced water is frozen immediately after being produced.

### Effect of the Invention

According to the present invention, it is possible to provide hydrogen-reduced water and drink, capable of efficiently removing active oxygen by raising a rate of temperature change of the hydrogen-reduced water to increase reactive contact between the active oxygen in human body and hydrogen, and also provide a production method and a storage method of the hydrogen-reduced water.

### BRIEF DESCRIPTION OF THE DRAWINGS

FIG. 1 shows a process of producing hydrogen-reduced water A according to the present invention.

FIG. 2 shows a process of producing hydrogen-reduced water B according to the present invention.

### EXPLANATION OF REFERENCE NUMERALS

101, 201 Tap water
102, 202 Activated carbon filter
104, 204 Raw water
105, 205 Raw water storage tank
106, 206 Nitrogen gas
107, 207 Reaction tank
108, 208 Hydrogen gas
109, 209 Product storage tank
110, 210 Ultrafiltration membrane
111, 211 Sterilization filter tube
112, 212 Micropore filter
113, 213 Hydrogen-reduced water
114, 214 Automatic filling device
115, 215 Disinfecting device
116, 216 Product
203 Prefilter

### BEST MODE FOR CARRYING OUT THE INVENTION

Next, an embodiment of hydrogen-reduced water according to the present invention will be described. The hydrogen-reduced water according to the present invention is characterized in that a rate of temperature change thereof is higher, under a predetermined temperature condition, than that of a water not containing hydrogen therein. In the present embodiment, the term a “rate of temperature change” represents a rate expressed as [temperature after being heated/cooled—initial temperature]/time, and a “high rate of temperature change” means one of that: a temperature decreasing rate is high; a temperature increasing rate is high; and both of the temperature decreasing rate and the temperature increasing rate are high. It should be noted that a rate of temperature change in the present invention represents that observed within the range of 1 to 50° C.

Measurement of a temperature decreasing rate is carried out by measuring a change in temperature for a period of time, about 5 to 20 minutes, counted from placing the subject water to be measured in a cool bath. Similarly, measurement of a temperature increasing rate is carried out by measuring a change in temperature for a period of time, about 5 to 20 minutes, counted from placing the subject water to be measured in a hot bath.

When a temperature decreasing rate and a temperature increasing rate of a subject water are relatively high, the subject water is likely to reach the same temperature as the temperature of water in a human body in a relatively short time after the subject water is incorporated into the body. This facilitates integration of the subject water with the water in the body, whereby reactive contact between the subject or hydrogen-reduced water and activated oxygen is facilitated, as well. Preferably, the ratio of a rate of temperature change of the hydrogen-reduced water according to the present invention, with respect to a rate of temperature change of the raw water, is more than 1 and equal to or less than 2.

The concentration of hydrogen dissolved in the hydrogen-reduced water at 20° C. is preferably set at 1.8 ppm or larger. Thermal conductivity of the hydrogen-reduced water tends to decrease when the dissolved hydrogen concentration is less than 1.8 ppm. The thermal conductivity of hydrogen molecule is generally 41.81 cal/sec·cm° C. (0.181 W/m·K), which is much higher than those of other gases, for example, the thermal conductivity of oxygen molecule [5.70 cal/sec·cm° C. (0.025 W/m·K)], the thermal conductivity of nitrogen molecule [5.81 cal/sec·cm° C. (0.025 W/m·K)] and the thermal conductivity of carbon dioxide molecule [3.39 cal/sec·cm° C. (0.014 W/m K)]. Accordingly, it is reasonably assumed that the thermal conductivity of the hydrogen-reduced water having hydrogen molecule dissolved therein is relatively high. The dissolved hydrogen concentration is a value measured by using a dissolved hydrogen analyzer.

Preferably, a concentration of oxygen dissolved in the hydrogen-reduced water at 20° C. is set at 2.55 ppm or lower. Thermal conductivity of water tends to decrease when the dissolved oxygen concentration exceeds 2.55 ppm. This is because the thermal conductivity of oxygen molecule is lower than that of hydrogen molecule. Further, the lower dissolved oxygen concentration is the more preferable in terms of increasing the amount of hydrogen dissolved in the water. The dissolved oxygen concentration is a value measured by using a dissolved oxygen meter.

Preferably, an oxidation reduction potential of the hydrogen-reduced water at 20° C. is −500 mV or lower. In a case where the oxidation reduction potential is shifted toward the plus side than −500 mV, it becomes increasingly difficult to obtain sufficient reducibility to remove active oxygen in human body. By dissolving hydrogen, the oxidation reduction potential of the water is significantly shifted to the minus side. The term “oxidation reduction potential” as used in the present embodiment represents a parameter for judging an oxidation reduction property of water, and water (aqueous solution) whose oxidation reduction potential indicates a minus value is called reduced water and known to have reducibility.

The oxidation reduction potential of tap water is generally in the range of +500 to +700 mV and that of a well water or commercial mineral water is in the range of 0 to +500 mV. These are water having an oxidizing effect. In contrast, reduced water exhibiting a minus value as oxidation reduction potential has an effect of suppressing oxidation of metal or decomposition of food products. Reduced water is used as cleaning water for silicon wafers in semiconductor plants and for metals in metal plants. By dissolving hydrogen therein, the cleaning effect of water is enhanced. A device of producing hydrogen-reduced water is manufactured by water treatment manufacturers and the like, and is commercially available.

A fluctuation range of oxidation reduction potential of hydrogen-reduced water can be reduced to not larger than 4% by freezing the water when the hydrogen-reduced water is stored for a long period of time, preferably one year, in a container made of a hydrogen-permeable material. In the present embodiment, the term “a fluctuation range of oxidation reduction potential” represents a value expressed as [the initial value (=electric potential of hydrogen-reduced water at the time of manufacturing)−the measured value (=electric potential of the hydrogen-reduced water after elapse of a predetermined period of time)]/the initial value×100. If highly reducible oxidation reduction potential of reduced water cannot be maintained, the value of the water as a commercial product may be decreased.

Examples of the container made of a hydrogen-permeable material include a PET bottle and the like. In general, a container made of PET (polyethylene terephthalate) such as a PET bottle is not suitable for a container of hydrogen-reduced water because hydrogen in the hydrogen-reduced water passes through a wall of the container and is released to the outside. However, according to the present invention, release of hydrogen can be prevented from occurring for a long period of time by freezing the filled hydrogen-reduced water, even in a case where the hydrogen-reduced water is filled in the container as described above.

The storage method of hydrogen-reduced water according to the present invention causes the aforementioned superior effect when a hydrogen-permeable material is used for the container thereof. However, needless to say, the hydrogen-reduced water can be stored for a further longer period of time in a stable manner by using as the container a material less permeable to hydrogen such as aluminum pouch.

Further, a drink produced from the hydrogen-reduced water as described above, stored in a state that hydrogen is stably dissolved therein, requires only a relatively short time for freezing and, when it is defrosted from the stored (frozen) state to be a drink, requires only a relatively short time for thawing, whereby an energy cost required for heating or cooling can be lowered.

Next, a method of producing the hydrogen-reduced water according to the present invention will be described. The hydrogen-reduced water is produced by spraying, into a vessel filled with hydrogen gas pressurized at a pressure in a predetermined range, raw water in a form of mist having a concentration of dissolved oxygen lowered by bubbling a nitrogen gas into the raw water.

The type of the raw water need not be particularly limited and may be tap water or water containing minerals. However, ultrapure water in which impurity components such as minerals have been removed to the utmost limit is especially preferable as the raw water in terms of achieving a high rate of temperature change.

It is necessary to remove dissolved oxygen in raw water to dissolve a large amount of hydrogen in the raw water. Oxygen is conventionally removed by depressurizing the inside of a reaction chamber filled with water by using a vacuum pump. However, with this method, the degree of decrease in dissolved oxygen is not satisfactory. Further, the method of removing dissolved oxygen by bubbling hydrogen gas as described in JP 08-276104 cannot possibly cause sufficient decrease in dissolved oxygen concentration, either. The present inventor found out that, by bubbling a nitrogen gas in raw water (20° C.) having a dissolved oxygen concentration of 4.04 ppm, the dissolved oxygen concentration of the water is lowered to 1.70 ppm or lower, and by bubbling a nitrogen gas in another raw water (a dissolved oxygen concentration of 9.90 ppm at 20° C.), the dissolved oxygen concentration of the water is lowered to 2.55 ppm or lower. As a result of a study by the present inventor, it has been discovered that a dissolved oxygen concentration can be significantly decreased by bubbling nitrogen gas in raw water, as described above.

After this, the raw water is sprayed in a form of mist into a container filled with hydrogen gas pressurized at a pressure preferably in a range of 0.01 to 10 atmospheres, more preferably 0.01 to 8 atmospheres, to dissolve a large amount of hydrogen as possible. The pressure of the raw water to be sprayed is preferably maintained about 10% higher than the filling pressure of hydrogen. More preferably, a circulation cycle of extracting raw water supplied to the pressure container, from the container, and resupplying the extracted raw water to the pressure container may be repeated several times.

Examples of the means for spraying raw water in a form of mist include a structure where water is sprayed in a shower-like form by attaching a water spray cock (or water spray port) having a large number of small holes to an outlet. A diameter of each hole of this structure is preferably in the range of about 100 to 300 μm. A contact area of raw water with hydrogen gas is increased by spraying the raw water in a form of mist, whereby efficient dissolution of hydrogen can be achieved.

As the hydrogen gas, it is preferable to use hydrogen gas having high purity (hydrogen 99.999% or more) to maintain a uniform quality.

Solubility of hydrogen gas to raw water is significantly affected by a temperature of the raw water. The amount of hydrogen gas soluble in 1 cm³ water increases as the temperature of the water decreases. However, the condition of water becomes unstable due to generation of ice in a certain area or the like at a temperature lower than 4° C. Therefore, the temperature of the raw water to be sprayed is preferably in the range of 4 to 10° C., and more preferably, at 4° C.

According to the method of the present invention, it is possible to dissolve a large amount of hydrogen gas in raw water. As a result, it is possible to obtain hydrogen-reduced water having significantly high reducibility at the oxidation reduction potential of −600 to −500 mV, which far excels the oxidation reduction potential of the conventional electrolytic reduced water, of −300 to −200 mV.

Regarding a composition of the hydrogen-reduced water described above, the hydrogen-reduced water preferably contains hydrogen of 1.8 ppm or more, oxygen of 2.55 ppm or less (more preferably 1.70 ppm or less), and minerals and water as the balance.

Next, a method of storing the hydrogen-reduced water according to the present invention will be described. The hydrogen-reduced water is characteristically frozen immediately after being manufactured and stored in that state.

In a case where hydrogen-reduced water is stored in a container made of a hydrogen-permeable material (for example, PET bottle), hydrogen generally passes through a wall of the container and is released to the outside. For this reason, the release of hydrogen is conventionally suppressed by charging hydrogen-reduced water in an aluminum pouch and the like made of a material not permeable to hydrogen. However, even in such a case, reducibility of the hydrogen-reduced water may deteriorate after a long period of time.

In contrast, according to the storage method as described above, type of a storage container no longer affects storage of hydrogen-reduced water. Hydrogen-reduced water can be stored for a long period of time without losing high reducibility thereof by freezing the hydrogen-reduced water immediately after being manufactured.

### EXAMPLE

The hydrogen-reduced water according to the present invention will be described hereinbelow on the basis of an example. It should be noted that the present invention is not limited to the example below.

(Raw Water)

Although the type of raw water used in the present invention is not specifically limited, ultrapure water or purified water is preferable because an effect of dissolved hydrogen can be intensified by use thereof. Ultrapure water is water from which impurities such as mineral components contained in tap water, well water or river water, which we usually drink, are removed as much as techniques allow.

Ultrapure water contains almost no dissolved oxygen and the like and is very close to 100%-pure H₂O, which only theoretically exists. Electrical conductivity of the ultrapure water is normally 6×10⁻² μS/cm or lower, which is very near to the theoretical electrical conductivity (5.5×10⁻² μS/cm) of water at 25° C.

The ultrapure water is used as cleaning water for use in manufacturing very-large-scale integrated circuits, water for use in manufacturing optical fibers and liquid crystal displays, water for use in nuclear power plants, water for use in medical injections, and further, water for use in the neutrino detector “Kamiokande” and “Super-Kamiokande”. Ultrapure water is also frequently used in the field of the biotechnologies.

Ultrapure water is produced as described below. First, inorganic ions and the like are removed from water (tap water) treated in a general water purification plant, by using an ion exchanger or a reverse-osmosis-membrane purified water producing apparatus. Next, the water is passed through a deaerator to remove dissolved gases such as dissolved oxygen, is sterilized, desalted and then purified by removing solid particles by an ultrafilter or the like. Further, in a plant or the like where a large volume of ultrapure water is used, such as a semiconductor or liquid crystal plant, raw water is directly taken from a river, purified in large facilities, and wastewater thereof or the like is recycled for use.

The present inventor believed that that it is preferable to use a reverse osmosis membrane to produce ultrapure water for the hydrogen-reduced water according to the present invention. The reverse osmosis membrane is also referred to as an RO membrane and, when the raw water contains ions, salts and the like other than water, capable of removing them. A reverse osmosis membrane is used, other than for producing ultrapure water, for desalinating seawater, producing value-added purified water or ultrapure water for water-purifying treatment or industrial use, and recycling sewage.

Purified water is produced by a method similar to that of producing ultrapure water as described above, except that an ion exchanger is used in place of the RO membrane.

(Hydrogen-Reduced Water A)

A hydrogen-reduced water produced by using purified water as raw water will be referred to as “hydrogen-reduced water A” hereinafter. Water used for producing purified water is well water taken from a deep well or public tap water supplied from Toyama City Waterworks & Sewage Bureau. In the present Example, the tap water having oxidation reduction potential of +394 mV, a dissolved hydrogen concentration 0 ppm, and a dissolved oxygen concentration of 8.48 ppm at 20° C. is employed, but the raw water is not limited thereto.

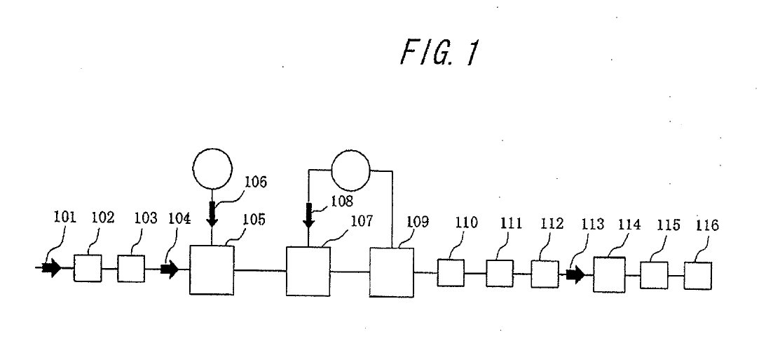

As shown in FIG. 1, tap water 101 passes through an activated carbon filter 102, and raw water (purified water) 104 thus produced is stored in a raw water storage tank 105 and is cooled to 4° C. Thereafter, nitrogen gas 106 is bubbled into the raw water 104 in the raw water storage tank 105 to reduce the concentration of oxygen dissolved in the raw water 104 to 2.55 ppm or lower.

Next, hydrogen gas 108 is filled in a reaction tank 107, and the raw water having a reduced concentration of oxygen dissolved therein is sprayed into the hydrogen gas at a pressure higher than the filling pressure (0.06 to 0.17 MPa) of the hydrogen gas 108 to dissolve hydrogen in the raw water. The water temperature at the time of dissolving hydrogen therein is maintained at 4° C. Dissolution and filling of hydrogen are continued until a dissolved hydrogen concentration and an oxidation reduction potential of the water containing hydrogen dissolved therein each reach a predetermined value. When the dissolved hydrogen concentration is equal to or excels a predetermined value and the oxidation reduction potential is equal to or below a predetermined value, the water is transferred to a product storage tank 109 (a hydrogen gas filling pressure is 0.06 MPa therein) to be stored. The dissolved hydrogen concentration and the oxidation reduction potential are measured by using a hydrogen concentration meter (manufactured by DKK-TOA CORPORATION) and an oxidation reduction potential meter (HM-21P manufactured by DKK-TOA CORPORATION, comparison electrode: silver-silver chloride), respectively.

Next, after being passed through an ultrafilter membrane (UF membrane) 110, the water is caused to pass through a sterilization filter tube (a depth cartridge filter made of polypropylene, manufactured by Advantec Ltd.) 111 and a micropore filter 112 to further ensure safety thereof. The ultrafilter membrane (UF membrane) is one type of a filter membrane for filtering liquid. The size of each pore of the UF membrane is about 2 to 200 nanometers, which is larger than that of a reverse osmosis membrane and smaller than that of a micropore filter membrane. The ultrafilter membrane is used in various fields. The ultrafilter membrane is used for removing bacteria or viruses in the water-purifying (tap water producing) field, for separating or condensing a heat-labile substances such as protein and enzyme in the industrial field, and for removing viruses or endotoxin (pyrogen) at the time of dialysis or manufacturing pharmaceuticals or water for medical applications in the medical field. Since picornavirus and parvovirus, which are presumably the smallest viruses that have ever been found, have a size of about 20 nm, the ultrafilter membrane can remove all of the pathogenic bacteria or viruses from liquid by setting the size of the pores at about 10 nm or smaller.

The hydrogen-reduced water 113 is filled into an aluminum pouch (internal volume of 350 ml or 500 ml) by using an automatic filling device 114. After the hydrogen-reduced water is filled in a container and the container is sealed by a cap, the weight of the hydrogen-reduced water is measured. The quality of the hydrogen-reduced water is controlled by adjusting a filled weight, an oxidation reduction potential, a dissolved hydrogen concentration and a dissolved oxygen concentration. In the present Example, the oxidation reduction potential is −632 mV, the dissolved hydrogen concentration is 2.90 ppm, and the dissolved oxygen concentration is 0.96 ppm at 20° C. The concentration of dissolved oxygen is measured by an oxygen concentration analyzer (portable dissolved oxygen meter, DO-24P).

Thereafter, the hydrogen-reduced water filled in the storage container is subjected to a disinfection treatment by a disinfecting device 115.

The hydrogen-reduced water A thus produced is packed and shipped as a product 116.

(Hydrogen-Reduced Water B)

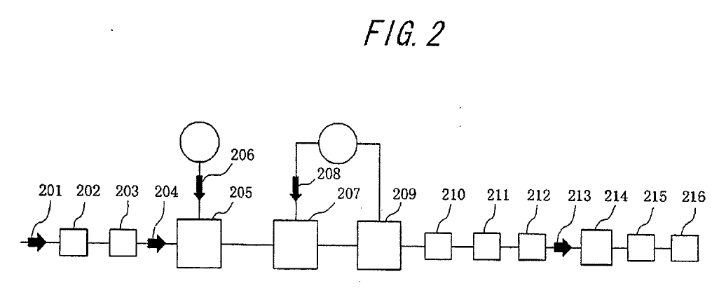

A hydrogen-reduced water produced by using ultrapure water as raw water will be referred to as “hydrogen-reduced water B” hereinafter. As shown in FIG. 2, the tap water 201 having oxidation reduction potential: +394 mV, dissolved hydrogen concentration: 0 ppm, and dissolved oxygen concentration: 8.48 ppm at 20° C. is passed through an activated carbon filter 202 and then a prefilter 203. The prefilter 203 is a RO membrane (also known as reverse osmosis membrane), which is a spiral-type reverse osmosis membrane module manufactured by Daicen Membrane Systems Ltd. In a case where water contains ions and/or salts (positive ion such as calcium, magnesium, sodium and iron ions, and negative ion such as silicic acid, chloride and carbonic acid ions) other than water, these impurities are removed by passing through the RO membrane.

The raw water (ultrapure water) 204 produced as described above is stored in a raw water storage tank 205 and cooled to 4° C. Thereafter, nitrogen gas 206 is bubbled into the cooled raw water 204 to reduce a concentration of oxygen dissolved in the raw water 204.

Next, hydrogen gas 208 is filled in a reaction tank 207, and the raw water having a reduced concentration of oxygen dissolved therein is sprayed into the hydrogen gas at a pressure higher than the filling pressure (0.06 to 0.17 MPa) of the hydrogen gas 208 to dissolve hydrogen in the raw water. The water temperature at the time of dissolving hydrogen therein is maintained at 4° C. Dissolution and filling of hydrogen are continued until a dissolved hydrogen concentration and an oxidation reduction potential of the water containing hydrogen dissolved therein each reach a predetermined value. When the dissolved hydrogen concentration is equal to or excels a predetermined value and the oxidation reduction potential is equal to or below a predetermined value, the water is transferred to a product storage tank 209 (a hydrogen gas filling pressure is 0.06 MPa therein) to be stored. The dissolved hydrogen concentration and the oxidation reduction potential are measured by using a hydrogen concentration meter (manufactured by DKK-TOA CORPORATION) and an oxidation reduction potential meter (HM-21P manufactured by DKK-TOA CORPORATION, comparison electrode: silver-silver chloride), respectively.

Next, the hydrogen-reduced water is passed through an ultrafilter membrane (UF membrane) 210 and then a sterilization filter tube (a depth cartridge filter made of polypropylene, manufactured by Advantec Ltd.) 211 and a micropore filter 212 to further ensure safety thereof. Hydrogen water produced by using ultrapure water does not contain ion or salt but may contain bacteria or viruses. If there exists any possibility that the hydrogen-reduced water thus produced contains bacteria and virus, a process capable of removing them may be added so that safe and quality-guaranteed hydrogen water can be provided to consumers. For this purpose, the produced hydrogen water is caused to pass through the ultrafilter membrane as described above. By adding this treatment, the bacteria can be completely removed and the water is made really safe and desirable as drink.

The hydrogen-reduced water 213 is filled into an aluminum pouch (internal volume of 350 ml or 500 ml) by using an automatic filling device 214. After the hydrogen-reduced water is filled in a container and the container is sealed by a cap, the weight of the hydrogen-reduced water is measured. The quality of the hydrogen-reduced water is controlled by adjusting a filled weight, an oxidation reduction potential, a dissolved hydrogen concentration and a dissolved oxygen concentration. In the hydrogen-reduced water 213 of the present Example, the oxidation reduction potential is −577 mV, the dissolved hydrogen concentration is 2.60 ppm, and the dissolved oxygen concentration is 1.40 ppm at 20° C. The concentration of dissolved oxygen is measured by an oxygen concentration analyzer (portable dissolved oxygen meter, DO-24P) was used.

Thereafter, the hydrogen-reduced water filled in the storage container is subjected to a disinfection treatment by a disinfecting device 215.

The hydrogen-reduced water B thus produced is packed and shipped as a product 216.

A composition of the hydrogen-reduced water A includes, per 300 ml of the hydrogen-reduced water A, lipid and carbohydrate: 0 mg, sodium: 1.62 mg, calcium: 6 mg, magnesium: 0.72 mg, and potassium: 0.42 mg. A composition of the hydrogen-reduced water B includes, per 180 ml of hydrogen-reduced water B, lipid and carbohydrate: 0 mg, sodium: 0 mg, calcium: 0 mg, magnesium: 0 mg, potassium: 0 mg, protein: 0.0 g, and ash: 0.0 g.

### Experiment Example 1

There was prepared a container X filled with hydrogen-reduced water A1 produced by a method similar to the aforementioned method of producing hydrogen oxidation water A and a container Y filled with water (raw water) not having hydrogen dissolved therein. The hydrogen-reduced water A1 had 1.8 ppm of dissolved hydrogen concentration, 1.8 ppm of dissolved oxygen concentration, and −600 mV of oxidation reduction potential. According to an analysis, the hydrogen-reduced water A contained as other components, per 180 ml of the hydrogen-reduced water A, energy: 0 kcal, protein: 0.0 g, lipid: 0.0 g, carbohydrate: 0.0 g, sodium: 0 mg, sodium chloride equivalent: 0.0 g, water content: 179.8 g, ash: 0.0 g, calcium: 0 mg, potassium: 0 mg, magnesium: 0 mg, and specific gravity: 0.998. The water not having hydrogen dissolved therein contained 0 ppm of dissolved hydrogen concentration, and 9.9 ppm of dissolved oxygen concentration. The raw water was well water taken from a deep well in Toyama city or public tap water supplied from Toyama City Waterworks & Sewage Bureau. As a result of analysis, the tap water taken on Nov. 21, 2006 included nitrate nitrogen and nitrite nitrogen: less than 1 mg/L, sodium: 3.0 mg/L, chloride ion: 4.3 mg/L, hardness (Ca, Mg, etc.): 30.6 mg/L, evaporation residue: 67 mg/L, and had +400 mV of oxidation reduction potential.

Three containers were prepared for each of the containers X and Y and they were placed into a water bath filled with ice to be cooled. The water temperature in each of the containers was 4.9° C. at the start of the cooling. A temperature in each container was measured by inserting a thermistor thermometer into the container at five-minute intervals. Temperatures of water in each container measured at predetermined time intervals (each value was the average of water temperatures of three containers) are shown in Table 1. In each measurement, the hydrogen-reduced water A1 according to the present invention exhibited a lower temperature than the raw water.

TABLE 1

| | | Hydrogen-reduced water A1 |
|---|---|---|
| | Raw water (° C.) | (° C.) |
| Start of cooling | 4.9 | 4.9 |
| After 5 minutes | 4.4 | 3.9 |
| After 10 minutes | 3.3 | 2.7 |
| After 15 minutes | 2.7 | 2.3 |
| After 20 minutes | 2.3 | 2.0 |
| After 25 minutes | 2.0 | 1.8 |
| After 30 minutes | 1.9 | 1.7 |
| After 35 minutes | 1.8 | 1.6 |

By plotting on a graph a relationship between temperature and time shown in Table 1, it was found that temperatures linearly decreased in first 15 minutes after the start of cooling in both types of water. On this basis, a temperature decreasing rate was obtained from the change in temperature during this period for each of the waters. The temperature of the raw water was 4.9° C. at the start of cooling and dropped to 2.7° C. after 15 minutes. In contrast, the temperature of the hydrogen-reduced water A1 was 4.9° C. at the start of cooling and dropped to 2.3° C. after 15 minutes. The temperature decreasing rate in this period was 0.14° C./min for the raw water, while 0.17° C./min for the hydrogen-reduced water A1. Accordingly, the temperature decreasing rate of the hydrogen-reduced water A1 was higher than that of the raw water.

### Experimental Example 2

There was prepared a container X filled with a hydrogen-reduced water A2 produced according to the method of producing the hydrogen oxidation water A as described above and a container Y filled with a water not having hydrogen dissolved therein. The hydrogen-reduced water A2 had 1.8 ppm of dissolved hydrogen concentration, 1.8 ppm of dissolved oxygen concentration, and −500 mV of oxidation reduction potential. In contrast, the water not having hydrogen dissolved therein had 0 ppm of dissolved hydrogen concentrate, 9.9 ppm of dissolved oxygen concentration, and +400 mV of oxidation reduction potential.

Three containers were prepared for each of the containers X and Y and they were placed into a water bath filled with ice to be cooled. The water temperature in each of the containers was 14.8° C. at the start of the cooling. A temperature in each container was measured by inserting a thermistor thermometer into the container at five-minute intervals. Temperatures of water in each container measured at predetermined time intervals (each value was the average of water temperatures of three containers) are shown in Table 2. In each measurement, the hydrogen-reduced water A2 according to the present invention exhibited a lower temperature than the raw water.

TABLE 2

| | | Hydrogen-reduced water A2 |
|---|---|---|
| | Raw water (° C.) | (° C.) |
| Start of cooling | 14.8 | 14.8 |
| After 5 minutes | 11.6 | 9.5 |
| After 10 minutes | 7.6 | 5.3 |
| After 20 minutes | 5.8 | 3.6 |
| After 35 minutes | 2.6 | 1.9 |
| After 42 minutes | 2.4 | 1.6 |
| After 50 minutes | 1.7 | 1.4 |
| After 55 minutes | 1.6 | 1.3 |
| After 60 minutes | 1.3 | 1.2 |
| After 65 minutes | 1.3 | 1.1 |

By plotting on a graph a relationship between temperature and time shown in Table 2, it was found that temperatures linearly decreased in first 10 minutes after the start of cooling in both types of water. On this basis, a temperature decreasing rate was obtained from the change in temperature during this period for each of the waters. The temperature of the raw water was 14.8° C. at the start of cooling and dropped to 7.6° C. after 10 minutes. In contrast, the temperature of the hydrogen-reduced water A2 was 14.8° C. at the start of cooling and dropped to 5.3° C. after 10 minutes. The temperature decreasing rate during this period was 0.72° C./min for the raw water, while 0.95° C./min for the hydrogen-reduced water A2. Accordingly, the temperature decreasing rate of the hydrogen-reduced water A2 was higher than that of the raw water.

### Experimental Example 3

The sample containers cooled in Experimental Example 1 were immersed into a bath containing water at 22° C., and a water temperature of the inside of each of the containers was measured at predetermined time intervals. Water temperatures after the predetermined periods of time are shown in Table 3.

TABLE 3

| | | Hydrogen-reduced water A1 |
|---|---|---|
| | Raw water (° C.) | (° C.) |
| Start of heating | 2.5 | 2.5 |
| After 5 minutes | 3.1 | 3.4 |
| After 10 minutes | 3.7 | 5.3 |
| After 20 minutes | 5.2 | 8.0 |
| After 35 minutes | 6.6 | 8.4 |
| After 43 minutes | 7.2 | 8.4 |
| After 50 minutes | 7.8 | 9.0 |
| After 55 minutes | 8.0 | 9.7 |
| After 60 minutes | 8.8 | 9.9 |
| After 70 minutes | 10.8 | 11.0 |
| After 80 minutes | 10.2 | 11.2 |
| After 90 minutes | 10.6 | 11.3 |

By plotting on a graph a relationship between temperature and time after the start of the experiment shown in Table 1, it was found that temperatures linearly decreased in first 20 minutes. On this basis, a temperature increasing rate for 20 minutes from the start of heating was obtained for each of the waters. Since temperature of the raw water increased from 2.5° C. to 5.2° C., a temperature increasing rate thereof was 0.14° C./min. Since temperature of the hydrogen-reduced water increased from 2.5° C. to 8.0° C., a temperature increasing rate thereof was 0.28° C./min. As described above, the temperature of the hydrogen-reduced water A1 was higher than that of the raw water and thus the temperature increasing rate of the hydrogen-reduced water A1 was higher than that of the raw water.

### Experimental example 4

The sample containers cooled to approximately 2° C. in Experimental Example 2 were immersed into a bath containing water at 15° C. When a water temperature of the inside of each of the containers was measured after five minutes, the temperature of the raw water was 10.7° C., while that of the hydrogen-reduced water A2 of the present invention was 12.8° C. A temperature increasing rate was 1.74° C./min for the raw water, while 2.16° C./min for the hydrogen-reduced water A2. Accordingly, the temperature of the hydrogen-reduced water A2 increased faster than that of the raw water.

### Experimental example 5

Next, the respective sample containers described above were immersed in a bath containing water at 37° C. A water temperature of each of the containers was measured at predetermined time intervals. A temperature when the experiment started was 28° C. for both the raw water and the hydrogen-reduced water A2. After 10 minutes, the temperature was 29.8° C. for the raw water, while 30.3° C. for the hydrogen-reduced water A2. A temperature increasing rate during this period was 0.18° C./min for the raw water, while 0.23° C./min for the hydrogen-reduced water A2. Accordingly, the temperature of the hydrogen-reduced water A2 increased faster than that of the raw water.

### Experimental example 6

Next, the hydrogen-reduced water A2 and the raw water in the respective containers were placed in a cooling chamber or a freezer (6.9° C.) to be cooled. A water temperature of the inside of each of the containers taken out from the cooling chamber was 7.1° C. These containers were immersed into a water bath at 40.8° C., and a water temperature of each of the containers was measured at predetermined time intervals. The temperature when the experiment started was 7.1° C. for each of the containers. A relationship between elapsed time and water temperature is shown in Table 4.

TABLE 4

| | | Hydrogen-reduced water A2 |
|---|---|---|
| | Raw water (° C.) | (° C.) |
| Start of heating | 7.1 | 7.1 |
| After 2 minutes | 21.7 | 22.7 |
| After 4 minutes | 23.9 | 25.4 |
| After 6 minutes | 25.9 | 26.8 |
| After 8 minutes | 27.9 | 28.4 |
| After 10 minutes | 28.3 | 29.1 |

At any elapsed time, the water temperature of the hydrogen-reduced water A2 was higher than that of the raw water. A temperature increasing rate was obtained for each type of water for first four minutes during which the temperature increased linearly in both waters. It was found that the temperature increasing rate was 4.6° C./min for the hydrogen-reduced water A2, while 4.2° C./min for the raw water. Accordingly, the temperature increasing rate of the hydrogen-reduced water A2 was higher than that of the raw water.

From the results shown in Experimental Examples 1-6, it is understood that the hydrogen-reduced water according to the present invention has a rate of temperature change higher than that of the water not having hydrogen contained therein.

### Experimental Example 7

Temporal changes in oxidation reduction potential, dissolved oxygen concentration, and dissolved hydrogen concentration of the hydrogen-reduced water were measured, respectively, and relationships therebetween were studied. Specifically, hydrogen-reduced water A immediately after being manufactured was unsealed and a content thereof was put into a beaker. An electrode for measuring oxidation reduction potential, an electrode for measuring dissolved hydrogen concentration, and an electrode for measuring dissolved hydrogen concentration were inserted into the beaker, respectively, to carry out measurement by each electrode, from immediately after being unsealed, at predetermined time intervals. The results are shown in Table 5. After the water A was unsealed, the oxidation reduction potential exhibited substantially no temporal change, while the dissolved oxygen concentration increased and the dissolved hydrogen concentration thereof decreased as time elapsed.

TABLE 5

| | Oxidation | | |
|---|---|---|---|
| Elapsed time | reduction | Dissolved oxygen | Dissolved hydrogen |
| (hour) | potential (mV) | concentration (ppm) | concentration (ppm) |
| 0 | −632 | 0.96 | 2.90 |
| 1 | −631 | 1.72 | 2.10 |
| 2 | −633 | 1.76 | 1.92 |
| 3 | −633 | 1.81 | 1.80 |
| 4 | −631 | 2.42 | 1.71 |
| 5 | −629 | 2.52 | 1.56 |
| 6 | −628 | 2.87 | 1.40 |
| 7 | −624 | 2.99 | 1.20 |
| 8 | −623 | 4.13 | 1.74 |

Temporal changes in oxidation reduction potential, dissolved oxygen concentration, and dissolved hydrogen concentration of hydrogen-reduced water were measured, respectively, and relationships therebetween were studied. Specifically, hydrogen-reduced water B immediately after being manufactured was unsealed and a content thereof was put into a beaker. An electrode for measuring oxidation reduction potential, an electrode for measuring dissolved hydrogen concentration, and an electrode for measuring dissolved hydrogen concentration were inserted into the beaker, respectively, to carry out measurement by each electrode, from immediately after being unsealed, at predetermined time intervals. The results are shown in Table 6. After the water B was unsealed, the oxidation reduction potential exhibited substantially no temporal change, while the dissolved oxygen concentration increased and the dissolved hydrogen concentration thereof decreased as time elapsed.

TABLE 6

| | Oxidation | | |
|---|---|---|---|
| Elapsed time | reduction | Dissolved oxygen | Dissolved hydrogen |
| (hour) | potential (mV) | concentration (ppm) | concentration (ppm) |
| 0 | −577 | 1.40 | 2.60 |
| 1 | −576 | 1.42 | 2.05 |
| 2 | −574 | 2.10 | 1.67 |
| 3 | −575 | 2.11 | 1.65 |
| 4 | −574 | 2.27 | 1.59 |
| 5 | −575 | 2.42 | 1.54 |
| 6 | −570 | 2.64 | 1.43 |
| 7 | −573 | 2.91 | 1.20 |
| 8 | −567 | 3.47 | 0.92 |

Further, a container of hydrogen-reduced water A immediately after being manufactured was unsealed, an oxidation reduction potential of the hydrogen-reduced water A was measured, and then the container was immediately sealed with a cap or a plug to be stored. The water A was unsealed again after 24 hours and the oxidation reduction potential thereof was measured. The oxidation reduction potential immediately after being manufactured was −644 mV, while the oxidation reduction potential after 24 hours was −643 mV, hardly showing any difference therebetween. Accordingly, it is understood that, if an aluminum pouch container is unsealed, the oxidation reduction potential can be prevented from being shifted toward the plus side, by sealing the pouch again.

### Experimental Example 8

Hydrogen-reduced water A produced by the method as described above was filled in 12 aluminum pouches, frozen in a freezer, and stored for a predetermined period of time. At the time of measurement, the hydrogen water in each aluminum pouch was taken out of the freezer, allowed to thaw at the room temperature, and the oxidation reduction potential thereof was measured. It took 12 hours for the frozen hydrogen-reduced water A to thaw. Each pouch was unsealed after the frozen hydrogen-reduced water A melted and the oxidation reduction potential of the water was measured immediately after the pouch was unsealed. For comparison, hydrogen-reduced water A stored at the room temperature was unsealed at the same time and by the similar method, and the oxidation reduction potential thereof was measured. The results are shown in Table 7.

TABLE 7

| | Stored at room temperature | Stored in frozen state |
|---|---|---|
| | (mV) | (mV) |
| Storage container | Aluminum pouch | Aluminum pouch |
| At the time of filling | −570 | −570 |
| After 1 week | −567 | −566 |
| After 2 weeks | −566 | −565 |
| After 3 weeks | −567 | −564 |
| After 5 weeks | −560 | −563 |
| After 7 weeks | −556 | −566 |
| After 9 weeks | −544 | −564 |
| After 11 weeks | −542 | −564 |
| After 13 weeks | −515 | −564 |
| After 15 weeks | −378 | −567 |
| After 17 weeks | −250 | −569 |
| After 19 weeks | −126 | −561 |

The oxidation reduction potentials one-week after the start of the storage were −567 mV for the room-temperature storage, and −566 mV for the frozen storage, which showed substantially no difference. The two values of oxidation reduction potentials of the two pouches still exhibited substantially no difference one day after the pouches were unsealed. Furthermore, even after two weeks, three weeks, and four weeks, these two types of waters still showed substantially the same values, i.e. substantially no difference therebetween.

The oxidation reduction potential was significantly shifted toward the plus side only in the room-temperature storage after 15 weeks from the start of the storage, resulting in a significant difference between the room-temperature storage and the frozen storage. The oxidation reduction potential in the room-temperature storage significantly decreased to −126 mV after 19-week from the start of the storage, which was a shift by approximately 444 mV toward the plus side from the value at the time of manufacture. In contrast, the hydrogen-reduced water stored in the frozen state hardly exhibited any change in oxidation reduction potential.

Further, difference in oxidation reduction potential between the room-temperature storage and the frozen storage further increased one day after unsealing the pouches. The oxidation reduction potential for the room-temperature storage was shifted further on the plus side, reaching +47 mV, while the potential in the product stored in the frozen state was −541 mV, which showed almost no increase.

### Experimental Example 9

Hydrogen-reduced water C is hydrogen-reduced water produced by a method similar to the method of producing the hydrogen-reduced water A filled in the aluminum pouch, except that the hydrogen-reduced water C is filled in a PET bottle. The hydrogen-reduced water C was filled in two PET bottles (each 350 ml), frozen in a freezer and stored for a predetermined period of time. At the time of measurement, the hydrogen water in each aluminum pouch was taken out of the freezer, allowed to thaw at the room temperature, and the oxidation reduction potential thereof was measured. It took 12 hours for the frozen hydrogen-reduced water C to thaw. Each pouch was unsealed after the frozen hydrogen-reduced water C melted and the oxidation reduction potential of the water was measured immediately after the pouch was unsealed. For comparison, hydrogen-reduced water C stored at the room temperature was unsealed at the same time and by the similar method, and the oxidation reduction potential thereof was measured. The results are shown in Table 8.

TABLE 8

| | Stored at room temperature | Stored in frozen state |
|---|---|---|
| | (mV) | (mV) |
| Storage container | PET bottle | PET bottle |
| At the time of filling | −683 | −683 |
| After 6 days | −619 | −678 |
| After 10 days | −608 | −673 |
| After 17 days | −252 | −664 |
| After 24 days | +113 | −656 |

As shown in Table 8, the oxidation reduction potentials after six-day storage were −619 mV for the room-temperature storage, and −678 mV for the frozen storage. However, the difference between the two storage states became significant by 24 days after the start of the storage. In the room-temperature storage, the oxidation reduction potential significantly changed to +113 mV after the pouch was unsealed, which was a shift by approximately 796 mV toward the plus side from the value at the time of filling. In contrast, almost no increase in the oxidation reduction potential was found in the hydrogen-reduced water stored in the frozen state.

Next, by comparing Experimental Examples 8 and 9 with each other, it is understood that the oxidation reduction potential at the room-temperature storage was shifted by 10 mV toward the plus side from the value at the time of filling after five-week storage in Experimental Example 8, while the oxidation reduction potential in the room-storage was shifted by 796 mV toward the plus side after 24-days storage in Experimental Example 9.

On the other hand, in Experimental Example 9, the product stored in the frozen state hardly exhibited any shift in oxidation reduction potential thereof even after 24-day storage, and the shift or the fluctuation range was about 0.6 to 4%. Further, it was confirmed that there hardly occurred any change in oxidation reduction potential up to one year from the start of the storage in the water.

### Comparative Example 1

Hydrogen-reduced water D was produced by a method similar to the method of producing the hydrogen-reduced water A as described above, except that nitrogen gas was not bubbled in the former. The hydrogen-reduced water after being filled in a container exhibited oxidation reduction potential of −632 mV, dissolved hydrogen concentration of 2.90 ppm, and dissolved oxygen concentration of 2.30 ppm at 20° C. Three containers were prepared for each of the hydrogen-reduced water D and the hydrogen-reduced water A1 used in Experimental Example 1, and an experiment similar to Experimental Example 1 was carried out.

By plotting on a graph a relationship between temperature and time after the start of cooling, it was found that temperature linearly decreased in first 15 minutes from the start of cooling in both types of water. Therefore, a temperature decreasing rate was obtained from the change in temperature during this period. The temperature of the hydrogen-reduced water A1 was 4.9° C. when the cooling was started and dropped to 2.3° C. after 15 minutes. In contrast, the temperature of the hydrogen-reduced water D was 4.9 when the cooling was started and dropped to 3.0° C. after 10 minutes. The cooling rate during this period was 0.13° C./min for the hydrogen-reduced water D and 0.17° C./min for the hydrogen-reduced water A1. Accordingly, the temperature decreasing rate of the hydrogen-reduced water A1 was higher that of the hydrogen-reduced water D.

### Comparative Example 2

The sample containers cooled in Comparative Example 1 were immersed into a bath containing water at 36° C., and water temperature of the inside of each container was measured at predetermined time intervals. By plotting on a graph a relationship between elapsed time after the start of the experiment and temperature, it was found that a linear or proportional relationship therebetween was maintained for the first 10 minutes. On this basis, a temperature increasing rate for the first 10 minutes after the start of the heating was obtained. Since the temperature of the hydrogen-reduced water D increased from 27° C. to 28.8° C., a temperature increasing rate thereof was 0.18° C./min. Since the temperature of the hydrogen-reduced water A1 increased from 27° C. to 29.3° C., a temperature increasing rate thereof was 0.23° C./min. Accordingly, the temperature of the hydrogen-reduced water A1 was higher than that of the hydrogen-reduced water D, and thus the temperature increasing rate of the hydrogen-reduced water A1 was higher that of the hydrogen-reduced water D.

### INDUSTRIAL APPLICABILITY

The present invention can provide hydrogen-reduced water and drink that contain a large amount of reactive substance having a high rate of reacting with active oxygen in human body and have a relatively high rate of temperature change, thereby being capable of efficiently removing the active oxygen, and also a production method and a storage method of the hydrogen-reduced water.

1-8. (canceled)

9. A hydrogen-reduced water, having under a predetermined temperature condition a rate of temperature change higher than that of a water not containing hydrogen therein.

10. The hydrogen-reduced water according to claim 9, wherein dissolved hydrogen concentration thereof is 1.8 ppm or more at 20° C.

11. The hydrogen-reduced water according to claim 9, wherein dissolved oxygen concentration thereof is 2.55 ppm or lower at 20° C.

12. The hydrogen-reduced water according to claim 10, wherein dissolved oxygen concentration thereof is 2.55 ppm or lower at 20° C.

13. The hydrogen-reduced water according to claim 9, wherein oxidation reduction potential thereof at 20° C. is −500 mV or lower.

14. The hydrogen-reduced water according to claim 10, wherein oxidation reduction potential thereof at 20° C. is −500 mV or lower.

15. The hydrogen-reduced water according to claim 11, wherein oxidation reduction potential thereof at 20° C. is −500 mV or lower.

16. The hydrogen-reduced water according to claim 12, wherein oxidation reduction potential thereof at 20° C. is −500 mV or lower.

17. The hydrogen-reduced water according to claim 9, wherein a fluctuation range of oxidation reduction potential of the hydrogen-reduced water in a frozen state is 4% or lower when the hydrogen-reduced water is stored in the state for a long period of time in a container made of a hydrogen-permeable material.

18. The hydrogen-reduced water according to claim 10, wherein a fluctuation range of oxidation reduction potential of the hydrogen-reduced water in a frozen state is 4% or lower when the hydrogen-reduced water is stored in the state for a long period of time in a container made of a hydrogen-permeable material.

19. The hydrogen-reduced water according to claim 11, wherein a fluctuation range of oxidation reduction potential of the hydrogen-reduced water in a frozen state is 4% or lower when the hydrogen-reduced water is stored in the state for a long period of time in a container made of a hydrogen-permeable material.

20. The hydrogen-reduced water according to claim 12, wherein a fluctuation range of oxidation reduction potential of the hydrogen-reduced water in a frozen state is 4% or lower when the hydrogen-reduced water is stored in the state for a long period of time in a container made of a hydrogen-permeable material.

21. The hydrogen-reduced water according to claim 13, wherein a fluctuation range of oxidation reduction potential of the hydrogen-reduced water in a frozen state is 4% or lower when the hydrogen-reduced water is stored in the state for a long period of time in a container made of a hydrogen-permeable material.

22. The hydrogen-reduced water according to claim 14, wherein a fluctuation range of oxidation reduction potential of the hydrogen-reduced water in a frozen state is 4% or lower when the hydrogen-reduced water is stored in the state for a long period of time in a container made of a hydrogen-permeable material.

23. The hydrogen-reduced water according to claim 15, wherein a fluctuation range of oxidation reduction potential of the hydrogen-reduced water in a frozen state is 4% or lower when the hydrogen-reduced water is stored in the state for a long period of time in a container made of a hydrogen-permeable material.

24. The hydrogen-reduced water according to claim 16, wherein a fluctuation range of oxidation reduction potential of the hydrogen-reduced water in a frozen state is 4% or lower when the hydrogen-reduced water is stored in the state for a long period of time in a container made of a hydrogen-permeable material.

25. A drink, produced from the hydrogen-reduced water according to claim 9.

26. A drink, produced from the hydrogen-reduced water according to claim 10.

27. A method of producing the hydrogen-reduced water according to claim 9, the method comprising spraying, into a vessel filled with hydrogen gas pressurized at a pressure in a predetermined range, raw water in a form of mist having a concentration of dissolved oxygen lowered by bubbling nitrogen gas into the raw water.

28. A method of storing the hydrogen-reduced water according to claim 9, further comprising storing the hydrogen-reduced water for a long period of time in a state where the hydrogen-reduced water is frozen immediately after being produced.
